(19) United States
(12) Patent Application Publication
(10) Pub. No.: US 2015/0139879 A1
(43) Pub. Date: May 21, 2015

(54) METHOD AND PLANT FOR REMOVING ACID COMPOUNDS FROM GASEOUS EFFLUENTS OF DIFFERENT ORIGINS

(71) Applicant: IFP Energies nouvelles, Rueil-Malmaison Cedex (FR)

(72) Inventors: Fabrice GIROUDIERE, Orlienas (FR); Adrien GOMEZ, Lyon (FR)

(21) Appl. No.: 14/546,253

(22) Filed: Nov. 18, 2014

(30) Foreign Application Priority Data
Nov. 19, 2013 (FR) 13/61.367

(51) Int. Cl. B01D 53/14; B01D 53/62; B01D 53/96; B01D 53/18

(52) U.S. Cl. CPC B01D 53/1456; B01D 53/18; B01D 53/1425; B01D 53/1475; B01D 53/62; B01D 53/96; B01D 53/1468; B01D 2252/204
USPC 423/228; 423/210; 422/611

(57) ABSTRACT

The invention relates to a method and a plant for removing the acid compounds contained in two gaseous effluents of different origins, comprising using a single amine-based absorbent solution circulating between a first absorber and a regenerator, and a second absorber and the same regenerator. The present invention advantageously applies for example to CO₂ capture within a single plant intended for capture of the gaseous effluents produced upon hydrogen production through steam reforming of a gaseous hydrocarbon feed, such as combustion fumes and syngas.

### FIELD OF THE INVENTION

The present invention relates to the sphere of deacidizing gaseous effluents comprising acid compounds such as carbon dioxide (CO₂) and hydrogen sulfide (H₂S) using an amine-based absorbent solution. The present invention applies in particular to CO₂ capture upon hydrogen production through steam reforming of a gaseous hydrocarbon feed and to H₂S removal from gaseous effluents produced upon hydrotreatment of liquid hydrocarbon feeds.

### General Context

Controlling greenhouse gas emissions, notably CO₂ emissions, is becoming an increasingly strong requirement for all economic sectors, in particular those concerning energy production. Industrial hydrogen production, generally based on natural gas steam reforming, is part of these sectors that emit large amounts of CO₂.

One of the various possible ways of controlling CO₂ emissions is CO₂ capture through absorption methods using an aqueous amine solution, for example alkanolamines such as monoethanolamine (MEA), diethanolamine (DEA) or N-methyldiethanolamine (MDEA). The CO₂ captured can be sequestered or re-used for various applications.

Such absorption methods can also be used for removing acid compounds contained in various types of gaseous effluents, among which the H₂S-rich acid gases produced upon oil refining in petroleum cut hydrotreatment processes.

During industrial hydrogen production from natural gas, a steam reforming reaction of the natural gas (or Steam Methane Reforming SMR) leading to the formation of syngas comprising carbon monoxide (CO) and dihydrogen (H₂) is carried out, followed by a reaction of conversion of the carbon monoxide (CO) to syngas so as to maximize the hydrogen production.

The steam reforming equilibrium reaction is written as follows for methane:

CH₄+H₂0 [symbol] CO+3H₂ΔH₂₉₈⁰=206.0 kJ/mol (1)

The CO conversion reaction, generally referred to as Water Gas Shift (WGS) reaction, is written as follows:

CO+H₂0 [symbol] CO₂+H₂ΔH₂₉₈⁰=−41.0 kJ/mol (2)

The balance of the two reactions is:

CH₄+2H₂0 [symbol] CO₂+4H₂ΔH₂₉₈⁰=165.0 kJ/mol (3)

The balance of these two reactions being highly endothermic, hydrogen production through steam reforming is conducted in furnaces operated at high temperature. The combustion fumes from these furnaces contain a large amount of CO₂ that it is advisable to capture prior to releasing the fumes to the atmosphere. Combustion fumes thus are a first source of CO₂ upon hydrogen production through natural gas steam reforming.

A second source of CO₂ upon industrial hydrogen production through steam reforming is the CO conversion reaction (2). The CO₂ thus formed has to be removed from the gas mixture, as well as the residual water, in order to produce almost pure hydrogen.

FIG. 1 illustrates such a hydrogen production method wherein CO₂ is captured in the combustion fumes from the furnaces.

A hydrocarbon feed 100, typically natural gas or naphtha, is supplied, in admixture with water vapour 113, to a catalytic reforming section 1000.

Reforming section 1000 is typically an exchanger reactor consisting of a shell containing a plurality of tubes, a structure referred to as shell and tube by the person skilled in the art, where the hydrocarbon feed circulates through the tubes and a heat-carrying fluid circulates outside the tubes. This heat-carrying fluid generally consists of combustion fumes. The combustion can be external to the reactor, as illustrated by burners 1004 in FIG. 1. The exchanger reactor can alternatively integrate the combustion generating the hot fumes, for example by means of integrated burners such as those described in patent FR-2,913,097. Such an exchanger reactor can then be referred to as a tube furnace.

Catalysts based on nickel supported on alumina for example are typically used in the tubes heated by radiation, in a tube furnace for example. The thermodynamics of steam reforming reactions leads to operate, at the reactor outlet, at the highest possible temperature so as to maximize the conversion of methane to hydrogen, typically a temperature ranging between 850° C. and 900° C. The furnace inlet temperature ranges for example between 540° C. and 580° C. The pressure of the process generally ranges between 20 and 30 bar abs.

An effluent 101 mainly containing syngas H₂+CO, and comprising water vapour H₂O, as well as CH₄ that has not been converted upon reforming, flows out of reforming section 1000. Other acid compounds such as CO₂, H₂S, mercaptans, COS, CS₂, the SO₂ initially contained in feed 100 can be present in effluent 101. Effluent 101 is sent after cooling to CO conversion section 1001 where the WGS reaction (2) described above is carried out. The water contained in hydrogen-rich mixture 102 at the outlet of section 1001 is removed by cooling and condensation in a section 1002 so as to produce water stream 103 and a hydrogen-rich and water-depleted mixture 104. Gas mixture 104 is then sent to a pressure-modulated adsorption purification unit (Pressure Swing Adsorption PSA) 1003. Two streams are then produced in unit 1003: a practically pure hydrogen stream 105 and a purge 106 containing CO₂, unconverted CH₄ and possibly other acid compounds initially present in feed 100. Purge 106 is generally used as fuel, in addition to another fuel 107 such as natural gas or a refinery gas/liquid, for feeding burners 1004 allowing to generate hot fumes 108 used as heat-carrying fluids in reforming section 1000.

Cooled combustion fumes 109 leaving steam reforming section 1000 can be treated in a CO₂ capture unit 1005 prior to being sent to a chimney. CO₂ capture can be performed using a fume scrubbing technology with an amine-based absorbent solution, by means of an absorber wherein the fumes are contacted with the absorbent solution so as to remove the CO₂ from the fumes, and a regenerator for thermally regenerating the absorbent solution and releasing the absorbed CO₂ it contains prior to recycling it to the absorber. Stream 110 represents the CO₂-purified fumes and stream 111 represents the CO₂-rich stream leaving the regenerator of capture unit 1005.

A major drawback of CO₂ capture according to FIG. 1 lies in the fact that a significant amount of CO₂ is captured on combustion fumes at atmospheric pressure, which requires using high absorbent solution flow rates, and therefore high flow rates of solution to be regenerated. Now, a main limitation of the methods based on the amine absorbent solutions commonly used today is the energy consumption necessary for regeneration of the solution. For example, it is well known that the energy required for regeneration by distillation of an amine solution can be divided into three different items: the energy required for heating the solvent between the top and the bottom of the regenerator, the energy required for lowering the acid gas partial pressure in the regenerator by vaporization of a stripping gas, and the energy required for breaking the chemical bond between the amine and the CO₂. These first two items are proportional to the absorbent solution flow rates to be circulated in the unit in order to achieve a given specification. Thus, the energy consumption required for regeneration is directly impacted by high flow rates of solution to be regenerated, as well as the size of the columns and the associated investment costs.

FIG. 2 illustrates the implementation of CO₂ capture at another level of the hydrogen production plant, allowing capture of the CO₂ produced by the reforming and CO conversion reactions. According to this figure, the CO₂ is captured in a CO₂ capture unit 1006 similar to unit 1005 of FIG. 1, positioned here downstream from CO conversion unit 1001 where the WGS reaction according to Equation (2) occurs and downstream from water condensation unit 1002. The CO₂ is removed from effluent 104 coming from cooling and condensation unit 1002 before it enters hydrogen purification PSA unit 1003. Stream 112 sent to purification unit 1003 is practically free of CO₂ and stream 111 leaving capture unit 1006 is rich in CO₂. Purge 106 produced in purification unit 1003 and used as fuel by burners 1004 practically contains no CO₂ any more.

A major drawback of this solution is that only part of the CO₂ produced during the hydrogen production process is captured: the part resulting from the reforming and CO conversion reactions, but not the part resulting from combustion in the furnace. Indeed, the CO₂ resulting from the combustion in burners 1004 is not captured. Combustion fumes 109 therefore contain the major part of the CO₂ generated by the combustion of the CH₄ that has not been converted in the reformer, which represents between 15% and 25% by mole of incoming CH₄, plus the CO₂ resulting from the combustion of backup fuel 107.

### PURPOSES AND SUMMARY OF THE INVENTION

The purpose of the present invention is to overcome at least partly the problems of the prior art as described above.

The present invention thus aims to provide a deacidizing method using an amine-based absorbent solution for efficient capture of the CO₂ formed upon industrial hydrogen production through steam reforming of a gaseous hydrocarbon feed, while limiting the investment cost of the CO₂ capture plant and the energy needs for regeneration of the absorbent solution.

More generally, the present invention aims to provide a method for removing the acid compounds contained in at least two gaseous effluents of different origins by means of an amine-based absorbent solution, while limiting the investment cost of the acid compound removal plant and the energy needs for regeneration of the absorbent solution.

According to the invention, gaseous effluents of different origins are understood to be gaseous effluents generally produced by different reactions, which may be distinguished by their composition, and generated under distinct operating conditions, notably different pressure and temperature conditions. Thus, the pressure of each one of the two gaseous effluents that can be treated according to the invention is different, notably the partial pressure of the acid compound(s) to be removed. Two gaseous effluents of different origins according to the invention are for example a combustion fume and syngas, both generated in a hydrogen production process through natural gas reforming. The two effluents can also be two H₂S-rich acid gases resulting from two distinct hydrodesulfurizations at different pressures of gasolines, kerosenes or diesel oils of different natures.

Thus, in order to reach at least one of the aforementioned purposes, among others, the present invention provides, according to a first aspect, a method of removing acid compounds contained in a gaseous effluent, comprising:
contacting, in a first absorption column operating at a first pressure P1, a first gaseous effluent containing acid compounds with a first stream of an aqueous absorbent solution comprising at least one amine, so as to produce a first gaseous effluent depleted in acid compounds and a first solution enriched in acid compounds,
contacting, in a second absorption column operating at a second pressure P2 at least 5 bar higher than first pressure P1, a second gaseous effluent containing acid compounds with a second absorbent solution stream, so as to produce a second gaseous effluent depleted in acid compounds and a second solution enriched in acid compounds,
regenerating the first and second solutions enriched in acid compounds in a regeneration column so as to produce a gas rich in acid compounds, a partly regenerated solution and a totally regenerated solution, and
sending said partly regenerated solution to the second absorption column so as to form the second absorbent solution stream and sending the totally regenerated solution to the first absorption column so as to form the first absorbent solution stream.

First pressure P1 in the first absorption column preferably ranges between 1 bar and 190 bar, and second pressure P2 in the second absorption column ranges between 10 bar and 200 bar.

According to an embodiment, second pressure P2 is at least 10 bar higher than first pressure P1, first pressure P1 ranges between 1 bar and 6 bar, and second pressure P2 ranges between 15 bar and 40 bar.

Preferably, the first solution enriched in acid compounds and the second solution enriched in acid compounds have an acid compound loading rate difference ranging between 5% and 30%.

The first solution enriched in acid compounds is preferably fed at an intermediate level along the regeneration column so that at least 50% of the acid compounds contained in said solution are released as gas in the regeneration column.

The partly regenerated solution is advantageously collected at a given height of the regeneration column above the height of discharge of the totally regenerated solution.

According to an embodiment, the method applies to CO₂ capture in a hydrogen production process through steam reforming of a gaseous hydrocarbon feed, wherein the first gaseous effluent is a combustion fume from a combustion stage in the hydrogen production process, and the second gaseous effluent is a hydrogen-rich CO₂-containing dry gas mixture, said mixture being obtained in the hydrogen production process after a stage of water gas shift reaction of the CO contained in the reforming effluents, and after a cooling and condensation stage.

According to an embodiment, the method applies to H₂S capture in a hydrocarbon feed hydrotreating process, wherein the first gaseous effluent and the second gaseous effluent to be treated are recycle gases produced in a first hydrotreating unit and in a second hydrotreating unit respectively. According to this embodiment, first pressure P1 preferably ranges between 20 bar and 190 bar, and second pressure P2 preferably ranges between 45 bar and 200 bar.

The present invention also provides, according to a second aspect, a plant for removing acid compounds contained in a gaseous effluent for implementing the method according to the invention. The plant comprises:
a first absorption column and a second absorption column, each comprising:
   gas-liquid contacting means,
   a first line at the column bottom for delivery of a gaseous effluent to be treated,
   a second line at the column top for delivery of an absorbent solution stream,
   a third line at the column top for discharge of a treated gaseous effluent depleted in acid compounds, and
   a fourth line at the column bottom for discharge of an absorbent solution enriched in acid compounds,
a regeneration column comprising:
   gas-liquid contacting means,
   a reboiler,
   a delivery line for a first solution enriched in acid compounds from the first absorption column,
   a delivery line for a second solution enriched in acid compounds from the second absorption column, at the column top,
   a discharge line for a gas rich in acid compounds, at the column top,
   a line for discharge of a totally regenerated absorbent solution to the first absorption column, at the column bottom,
   a line for discharge of a partly regenerated absorbent solution to the second absorption column.

The delivery line for the first solution enriched in acid compounds is preferably positioned at an intermediate level along the regeneration column, below the line delivering the second solution enriched in acid compounds.

Advantageously, the position of the delivery line for the first solution enriched in acid compounds is determined by taking simultaneously account of the loading rate and the temperature of said solution enriched in acid compounds entering the column, so as to minimize the heat consumption at the reboiler of the regeneration column.

Advantageously, the discharge line intended for the partly regenerated absorbent solution is positioned at a given height of the regeneration column above the discharge line intended for a totally regenerated absorbent solution.

### BRIEF DESCRIPTION OF THE FIGURES

Other features and advantages of the invention will be clear from reading the description hereafter of particular embodiments given by way of non-limitative example, with reference to the accompanying figures wherein:

FIGS. 1 and 2 are block diagrams of a plant implementing a method of producing hydrogen through reforming of a gaseous hydrocarbon feed integrating a CO₂ capture unit according to two known configurations,

FIG. 3 is a block diagram illustrating an embodiment of the method according to the invention in a hydrogen production plant based on reforming of a gaseous hydrocarbon feed,

FIG. 4 is a block diagram illustrating an embodiment of the deacidizing method according to the invention, and

FIG. 5 is a block diagram illustrating an embodiment of the method according to the invention for treating two H₂S-rich gases from two different hydrocarbon feeds in two distinct hydrotreating units.

In the figures, the same reference numbers designate identical or similar elements.

### DETAILED DESCRIPTION

The present invention aims to remove the acid compounds contained in two gaseous effluents of different origins, comprising using a single amine-based absorbent solution, an absorption column for each one of the two gaseous effluents to be deacidized and a single regenerator.

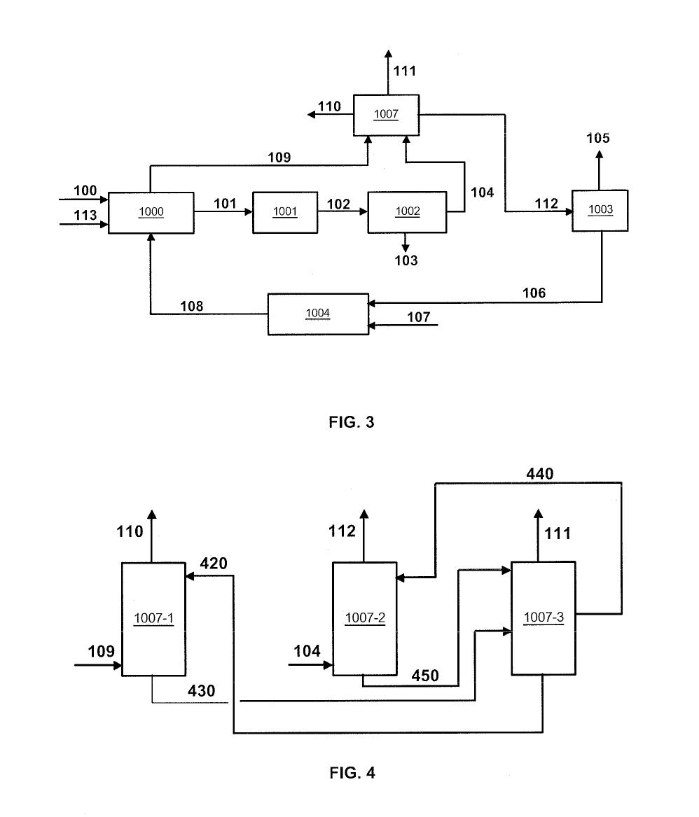

FIG. 3 illustrates the method according to the invention, implemented in a hydrogen production process based on steam reforming of a gaseous hydrocarbon feed such as natural gas or naphtha.

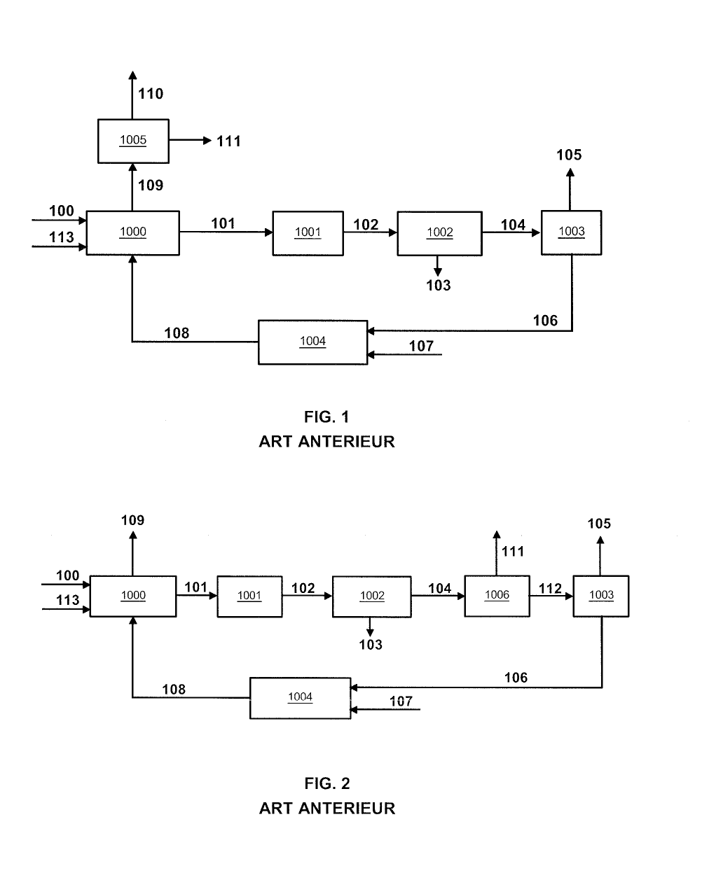

The hydrogen production method and the plant for implementing it are similar to those described in connection with FIGS. 1 and 2, except for the CO₂ capture integration. Thus, only some complements relative to the gas streams involved in the hydrogen production and a description relative to the CO₂ capture according to the invention are given hereafter.

Hydrocarbon feed 100 is a gaseous feed. The gaseous hydrocarbon feeds according to the invention include hydrocarbon feeds in gas form, liquid feeds after vaporization and volatile hydrocarbons from solid feeds.

Preferably, feed 100 is natural gas or naphtha. The natural gas is predominantly made up of gaseous hydrocarbons, but it can contain some of the following acid compounds: CO₂, H₂S, mercaptans, COS, CS₂. The proportion of these acid compounds is highly variable and it can be up to 70 vol. % for CO₂ and 40 vol. % for H₂S. Desulfurization of the feed can be carried out upstream from reforming unit 1000. In this case, the acid gases to be removed are essentially CO₂. The temperature of the natural gas can range between 20° C. and 100° C. The pressure of the natural gas can range between 10 and 120 bar.

Feed 100 preferably has a minimum steam-to-carbon (S/C) molar ratio in order to prevent coke formation on the catalyst and corrosion through metal dusting. Depending on the feeds, this ratio generally ranges between 2.5 and 3.5.

Combustion fumes 109 are produced by the combustion of a fuel 107 such as hydrocarbons, for example natural gas or a refinery gas/liquid, a biogas, etc., and preferably also by the combustion of purge 106. These fumes generally have a temperature ranging between 900° C. and 1400° C., a pressure ranging between 1 and 6 bar abs and they can contain between 50 and 80 vol. % nitrogen, between 5 and 40 vol. % CO₂, between 0.5 and 17 vol. % oxygen, and some impurities such as SOx and NOx.

Effluent 104 is a dry gas mixture rich in hydrogen, in a proportion typically ranging between 70 and 90 mol. %, also comprising CO₂, in a proportion ranging between 15 and 30 mol. %, mainly formed during the CO conversion reaction in unit 1001, as well as residual CH₄, ranging between 2 and 7%, and residual CO, in a proportion of less than 5%, and possibly a water residue that has not condensed during the cooling and condensation stage in unit 1002, and other compounds present in the initial feed 100. The pressure of effluent 104 ranges between 15 and 40 bar, preferably between 20 and 30 bar.

According to the invention, the CO₂ is captured in the gaseous effluents using a CO₂ capture unit 1007 receiving combustion fumes 109 and hydrogen-rich effluent 104. Each one of these two gaseous effluents 109 and 104 is treated in a distinct absorption column (not shown in FIG. 3) by contacting with an amine-based aqueous absorbent solution in order to remove the CO₂ contained in each of the two effluents. A CO₂-depleted gas flows out of each absorber: CO₂-depleted fumes 110 that can be sent to a chimney and discharged to the atmosphere, and a H₂-rich and CO₂-depleted stream 112 that is sent to purification unit 1003. A single absorbent solution is used for treating both gases 109 and 104, said solution circulating between each absorber and a single regenerator. Within the regenerator (not shown in FIG. 3), the absorbent solution laden with acid compounds after being contacted with effluents 109 and 104 is thermally regenerated so as to be re-used in the two absorbers, and the CO₂ is released to form a gas stream essentially containing CO₂ 111.

All of the CO₂ generated in the hydrogen production process can thus be potentially captured by means of the method according to the invention while minimizing the investment cost, by means of a single regenerator and a single absorbent solution used under conditions allowing optimum CO₂ capture, unlike conventionally known methods.

FIG. 4 gives more details on the implementation of the acid compound removal method according to the invention, with a schematic representation of the absorbent solution circuit, the two absorption columns 1007-1 and 1007-2, and the regeneration column 1007-3 used.

One may refer to the CO₂ capture application during hydrogen production to describe the method in reference to FIG. 4, it being understood that the present invention can be more generally implemented to treat two gaseous effluents 104 and 109 of different origins, without being limited to CO₂ capture.

The deacidizing plant comprises a first absorption column 1007-1 provided with gas-liquid contacting means, a random packing, a stacked packing or trays for example. The first gaseous effluent to be treated 109, for example combustion fumes 109 of FIG. 3, is conveyed through a line opening into the bottom of column 1007-1. A line at the top of column 1007-1 allows absorbent solution 420 to be delivered. A line at the top of the column allows treated (deacidized) gas 110, i.e. the CO₂-depleted combustion fumes, to be discharged, and another line positioned at the bottom of the column allows absorbent solution 430 enriched in acid compounds to be sent to a regeneration column 1007-3. The amount of acid compounds (moles), for example the amount of CO₂ (moles), in relation to the amount of amines (moles) is defined as the loading rate of the solution in acid compounds. For example, in cases where the absorbent solution used is a 30 wt. % MEA aqueous solution, solution 430 is laden with CO₂ with a loading rate ranging between 0.30 and 0.53 mol CO₂/mol MEA, preferably between 0.40 and 0.52 mol CO₂/mol MEA.

The deacidizing plant also comprises a second absorption column 1007-2, equipped like first absorption column 1007-1, comprising a line in the lower part of the column through which the second gaseous effluent to be treated 104, for example hydrogen-rich dry mixture 104 of FIG. 3, is conveyed. A line at the top of column 1007-2 allows another absorbent solution stream 440 to be fed for contacting with gas 104. A line at the top of column 1007-2 allows the treated (deacidized) gas 112, for example the H₂-rich and CO₂-depleted stream 112 of FIG. 3, to be discharged, and a line at the bottom of column 1007-2 allows a second absorbent solution enriched in acid compounds 450 to be discharged and sent to regeneration column 1007-3. For example, in cases where the absorbent solution used is a 30 wt. % MEA aqueous solution, solution 450 is laden with CO₂ with a loading rate ranging between 0.35 and 0.60 mol CO₂/mol MEA, preferably between 0.45 and 0.60 mol CO₂/mol MEA.

Preferably, absorbent solution 450 enriched in acid compounds flowing from second absorber 1007-2 and absorbent solution 430 enriched in acid compounds flowing from first absorber 1007-1 have an acid compound loading rate difference ranging between 5% and 30%.

Regeneration column 1007-3 is also equipped with gas-liquid contacting internals such as trays, random or packed packings for example. The bottom of column 1007-3 is equipped with a reboiler (not shown) that provides the heat required for regeneration by vaporizing a fraction of the absorbent solution. The delivery lines allowing the absorbent solutions to be supplied to the regeneration column are advantageously positioned in such a way that the temperature and the loading rate profile in the regeneration column is as monotonic as possible in relation to the natural evolution of the temperature and of the loading rate. Thus, the loading rate is higher at the regeneration column top and lower at the bottom of said column. The temperature is lower at the regeneration column top and higher at the bottom of said column. The positioning of the delivery lines of column 1007-3 takes simultaneously account of the loading rate and the temperature of the laden absorbent solution flowing into the column so as to minimize the heat consumption at the regeneration column reboiler. The final result is obtained from an iterative calculation. Among the two absorbent solutions 430 and 450 enriched in acid compounds, the one with the higher acid compound loading rate is introduced at a greater height in regeneration column 1007-3 than the one with the lower acid compound loading rate. The line carrying the first absorbent solution enriched in acid compounds 430 coming from first absorber 1007-1 opens into an intermediate part of the regeneration column, at a given height so selected that a major part of the acid compounds contained in the solution can be released through expansion with minimum energy consumption, as described above. The line allowing introduction of the absorbent solution enriched in acid compounds 450 from second absorption column 1007-2, in cases where the acid compound loading rate thereof is higher than that of solution 430, opens onto the upper part of regeneration column 1007-3, above the line delivering first solution 430 enriched in acid compounds, for deeper regeneration of this stream richer in acid compounds than solution 430. A line at the top of column 1007-3 allows discharge of the gas enriched in acid compounds released upon regeneration 111. A line arranged at the bottom of column 1007-3 allows discharge of a totally regenerated absorbent solution so as to form first absorbent solution stream 420 sent to first absorption column 1007-1. A line positioned at an intermediate level along column 1007-3, above the line allowing discharge of totally regenerated solution 420, allows extraction of a partly regenerated absorbent solution that makes up second absorbent solution stream 440 sent to second absorber 1007-2.

Heat exchangers (not shown) are preferably arranged on the absorber/regenerator circuit allowing recovery of the heat of the regenerated or partly regenerated absorbent solution from regeneration column 1007-3 in order to heat absorbent solutions 430 or 450 enriched in acid compounds and flowing out of the absorption columns. Pumps and valves, not shown, can also be arranged on the absorbent solution circuit in order to adjust the fluid pressures to the desired operating conditions and to facilitate their transportation from one column to the next.

Using a single regeneration column for deacidizing two gaseous effluents of different origins provides a significant investment cost gain.

The absorption performed in absorption columns 1007-1 and 1007-2 consists in contacting the gaseous effluent carried through the line at the column bottom with the absorbent solution stream carried through the line at the column top. Upon contacting, the amines of the absorbent solution react with the acid compounds contained in the effluents so as to obtain a gaseous effluent depleted in acid compounds that is discharged through the line at the absorption column top and an absorbent solution enriched in acid compounds discharged through the line at the absorption column bottom to be regenerated.

The first absorption stage carried out in first absorption column 1007-1 is performed at a pressure P1 that can range between 1 bar and 190 bar, preferably between 1 bar and 6 bar, more preferably between 1 bar and 3 bar, in the case of a combustion fume, and preferably between 40 bar and 190 bar for a recycle gas from a hydrocarbon feed hydrotreating unit. Pressure P1 preferably corresponds to the pressure of effluent 109 to be treated. The temperature in column 1007-1 can range between 20° C. and 90° C., preferably between 30° C. and 80° C. The pressures given in the present description are expressed in absolute unit (bar abs), unless otherwise specified.

The second absorption stage carried out in second absorption column 1007-2 is performed at a pressure P2 higher than pressure P1, at least 5 bar higher than pressure P1, preferably at least 10 bar higher than pressure P1 and more preferably at least 20 bar higher than pressure P1. Pressure P2 can range between 10 bar and 200 bar, preferably between 15 bar and 200 bar, more preferably between 15 bar and 40 bar in the case of H₂-rich gaseous effluent 104 of FIG. 3, and preferably between 45 bar and 200 bar for a recycle gas from a hydrocarbon feed hydrotreating unit. Pressure P2 preferably corresponds to the pressure of effluent 104 to be treated. The temperature in column 1007-2 can range between 20° C. and 90° C., preferably between 30° C. and 80° C. The absorption performed at a high pressure P2, notably at high partial pressures of the acid compounds in the effluent to be treated, allows more efficient absorption by the absorbent solution. The absorbent solution enriched in acid compounds at the bottom of second column 1007-2 can thus be highly laden with acid compounds, notably compared to absorbent solution 430 flowing from the bottom of first absorption column 1007-1.

The regeneration stage in regeneration column 1007-3 notably consists in heating and optionally in expanding the absorbent solutions enriched in acid compounds coming from the two absorption columns, so as to release the acid compounds in gas form.

The first absorbent solution enriched in acid compounds 430 leaving first column 1007-1 is fed into regeneration column 1007-3 at a given height of the column, for example at the level of a given tray, so that expansion of the solution is achieved in order to release at least 50% of the acid compounds contained in the solution. According to the invention, introducing solution 430 at an intermediate position along the column is sufficient for regeneration of this solution 430, and it thus allows to optimize the energy to be supplied for global regeneration. Preferably, prior to being fed into the regeneration column, solution 430 is first heated in a heat exchanger by the stream of totally regenerated solution 420 coming from regeneration column 1007-3.

The second absorbent solution enriched in acid compounds 450 leaving second column 1007-2 is introduced through a line at the top of the regeneration column. Prior to being fed into the regeneration column, solution 450 can be heated in a heat exchanger where stream 440 flowing from regeneration column 1007-3 circulates.

In regeneration column 1007-3, under the effect of the contacting of the absorbent solutions enriched in acid compounds with the steam produced by the reboiler, the acid compounds are released in gas form and discharged through a line located at the top of column 1007-3. A totally regenerated absorbent solution, i.e. nearly totally free of acid compounds, is discharged through a line at the bottom of column 1007-3, then recycled to first absorption column 1007-1 in order to form first absorbent solution stream 420. Solution 420 is preferably cooled in a heat exchanger where solution 430 circulates. A partly regenerated absorbent solution 440 is extracted at an intermediate level along regeneration column 1007-3, above the point where totally regenerated solution 420 is discharged, collected for example at the level of a given tray, so as to be recycled and to form second absorbent solution stream 440 fed into second absorption column 1007-2. The acid compound loading rate of the partly regenerated solution is between 5% and 30% higher than that of totally regenerated solution 420. Such a partly regenerated solution is sufficient for efficient removal of the acid compounds from second gaseous effluent 104 in the second absorber operating at high pressure, while allowing the energy required for global regeneration of the absorbent solution to be saved.

In cases where the absorbent solution used is a 30 wt. % MEA aqueous solution, a partly regenerated solution 450 is for example a solution having a CO₂ loading rate ranging between 0.20 and 0.50 mol CO₂/mol MEA, preferably between 0.25 and 0.40 mol CO₂/mol MEA, and a totally regenerated solution is for example a solution having a CO₂ loading rate ranging between 0.15 and 0.45 mol CO₂/mol MEA, preferably between 0.20 and 0.30 mol CO₂/mol MEA.

The regeneration stage of the method according to the invention is performed by thermal regeneration, optionally complemented by one or more expansion stages.

Regeneration can be carried out at a pressure in column 1007-3 ranging between 1 bar and 5 bar, or even up to 10 bar, and at a temperature in column 1007-3 ranging between 100° C. and 180° C., preferably between 110° C. and 170° C., and more preferably between 120° C. and 140° C.

The absorbent solution according to the invention is an aqueous solution comprising at least one amine. Said amine in aqueous solution has the capacity of absorbing at least one acid compound of the gaseous effluent to be treated. Primary, secondary or tertiary amines, i.e. comprising at least one primary, secondary or tertiary amine function, can be used.

By way of non-exhaustive example, the following amines can be used for the absorbent solution utilized in the method according to the invention: monoethanolamine (MEA), 2-amino-2-methyl-propanol (AMP), 1-amino-2-propanol, 2-amino-1-butanol, 1-(2-amino-ethyl)-pyrrolidine, diethanolamine (DEA), 2 (ethylamino) ethanol, 2-methylpiperazine, N-methyldiethanolamine (MDEA), 1-(dimethylamino)-2-propanol, N,N,N′,N′-Tetramethylhexane-1,6-diamine (TMHDA), 1-amino-6-pyrodinyl-hexane, Pentamethyl-dipropylenetriamine, N,N,N′,N′-Tetraethyldiethylenetriamine, Bis[2-(N,N-dimethylamino)-ethyl]ether. These amines can be used alone or in admixture.

The formulation of the solution is preferably determined according to the acid compound(s) to be removed and the partial pressures of the acid compounds in the gases to be treated. It may be advantageous to select a hindered tertiary or secondary amine for selective H₂S absorption, for example for treating recycle gases from the hydrotreatment process.

An aqueous solution is understood to be a solution containing at least 10 wt. %, inclusive, water.

The amine(s) can have variable concentrations in the absorbent solution, ranging for example between 10 and 90 wt. %, preferably between 20 and 60 wt. %, more preferably between 25 and 60 wt. %, and most preferably between 30 and 60 wt. %, inclusive of endpoints.

The absorbent solution can contain between 10 and 90 wt. % water, preferably between 25 and 80 wt. % water, more preferably between 30 and 70 wt. % water and most preferably between 40 and 70 wt. % water, inclusive of endpoints.

The absorbent solution can contain other compounds, for example one or more activator compounds allowing the absorption kinetics of the acid compounds to be accelerated, which can be a nitrogen compound comprising a primary or secondary amine function. Tertiary amines can thus be mixed with a primary or secondary amine, for example with one or more of the following amines: BenzylAmine, N-MethylBenzylAmine, N-EthylBenzylAmine, a-MethylBenzylAmine, a-EthylBenzylAmine, PhenethylAmine, TetraHydro-IsoQuinoline, IsoIndoline, ButylAmine, N-ButylPiperazine, MonoEthanolAmine, AminoEthyl-EthanolAmine, DiGlycolAmine, Piperazine, N-(2-HydroxyEthyl)Piperazine, N-(2-AminoEthyl) Piperazine, N-Methyl Piperazine, N-EthylPiperazine, N-PropylPiperazine, 1,6-HexaneDiAmine, 1,1,9,9-TetraMethylDi-PropyleneTriamine, Morpholine, Piperidine, 3-(MethylAmino)PropylAmine, N-MethylBenzylAmine.

The absorbent solution can also comprise a physical solvent such as methanol, sulfolane, polyethylene glycols that can be etherified, pyrrolidones or derivatives such as, for example, N-methylpyrrolidone, N-formyl morpholine, acetyl morpholine, propylene carbonate. For example, the absorbent solution comprises between 10 and 50 wt. % of a solvent of physical nature.

The absorbent solution can also comprise amine degradation inhibitor compounds or corrosion inhibitor compounds.

The present invention is not limited to the capture of CO₂ in fumes and the syngas that has undergone conversion through WGS during hydrogen production by steam reforming of natural gas.

More generally, it can apply to the treatment of gaseous effluents of different origins, notably gaseous effluents having different pressures. In order to make maximum use of the advantages afforded by the method according to the invention, the gaseous effluents to be treated exhibit a significant pressure difference, for example of the order of at least 5 bar, preferably at least 10 bar and more preferably at least 20 bar.

Thus, the method according to the invention can advantageously apply to the desulfurization of H₂S-rich gases formed during hydrotreatment of hydrocarbon feeds of different natures, under different pressure conditions.

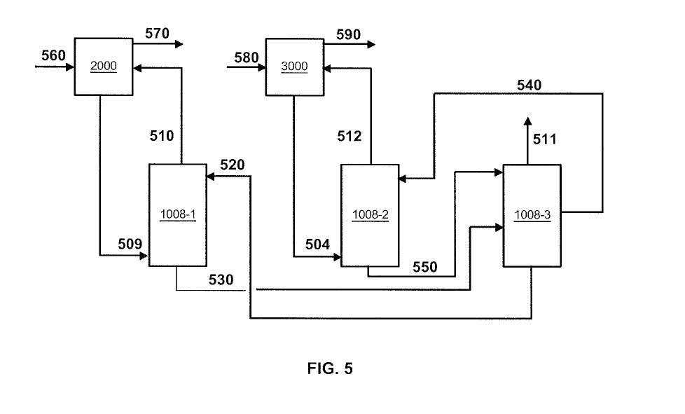

FIG. 5 diagrammatically illustrates such an application. The deacidizing plant according to the invention comprises the same devices described in connection with FIG. 4.

In this embodiment, the gaseous effluents to be deacidized 509 and 504 are recycle gases generated during the hydrotreatment of two different hydrocarbon feeds, for example a distillation gasoline and diesel oil requiring each separate hydrotreatment due for example to variable sulfur compounds depending on the feeds. These sulfur compounds are then referred to as more or less refractory. The more refractory a sulfur compound, the higher the hydrodesulfurization operating pressure.

Hydrotreatment of a hydrocarbon feed such as diesel oil in the sphere of petroleum refining is a process that is well known to the person skilled in the art. Such a method is for example described in U.S. Pat. No. 4,990,242. Hydrotreatment aims to desulfurize diesel oils. It consists in reacting a hydrocarbon feed mixed with a hydrogen-rich gas in a reactor at high temperature, the mixture being heated by heat exchangers and a furnace at a reaction temperature of the order of 340° C. to 370° C. prior to being fed to the reactor. The feed is sent to the reactor in vapour form if it is a light cut or in form of a liquid/vapour mixture if it is a heavy cut. The exothermicity of the reactions causes a temperature rise that can be controlled, for example through quenching with a cold liquid for cooling the mixture in the reactor. At the reactor outlet, the mixture is cooled and separated, which provides a H₂S-rich gas, light products resulting from the decomposition of impurities, and a hydrorefined product of same volatility as the feed, but with improved characteristics. In the separation stage, several devices are generally used, including a high-pressure separator drum allowing a hydrogen-rich gas to be recycled by means of a recycle compressor. This recycle gas contains H₂S that can be removed by washing with an absorbent amine solution. A high-pressure gas purge can also be provided to keep a sufficient hydrogen purity in the recycled gas. The deacidizing method according to the invention is implemented at this stage. In general, the separation section also comprises a low-pressure separator drum and a diesel steam stripper. The low-pressure separator drum allows to separate the liquid and vapour phases obtained by expansion of the liquid from the high-pressure drum. The gas mainly comprises hydrogen, light hydrocarbons and a large part of the hydrogen sulfide formed during the reaction. The purpose of the stripper is to remove the light hydrocarbons and the residual H₂S from the cut treated. The diesel oil is withdrawn at the column bottom with control of the operation with the flash point of the diesel oil. The residual H₂S is mixed with the H₂S-rich gas leaving the low-pressure separator drum so as to form the H₂S-rich gas leaving the hydrotreating unit.

The method according to the invention allows to remove the H₂S from recycle gases 509 and 504 coming from two distinct hydrotreating units 2000 and 3000. Each hydrotreating unit treats a different initial hydrocarbon feed 560 and 580, at different pressures, linked for example with the nature of the feed, the geographical origin of the crude oil and the distillation cut (gasoline/kerosene/diesel). A hydrorefined product 570 and a recycle gas 509 from which the H₂S is to be removed are obtained in first hydrotreating unit 2000. The pressure of the recycle gas ranges for example between 40 bar and 190 bar. The same applies to second hydrotreating unit 300 from which flow a hydrorefined product 590 and a recycle gas 504 containing H₂S to be removed, at a pressure ranging for example between 45 bar and 200 bar. The recycle gases are rich in hydrogen, typically between 60 and 95 mol %, and they can contain between 2% and 20% methane, between 1% and 10% ethane, less than 5% hydrocarbons with more than three carbon atoms, water traces, less than 5% water, and between 0.1% and 4% H₂S, preferably between 0.5% and 1.5% H₂S. Absorbers 1008-1 and 1008-2 allow the H₂S to be removed from recycle gas 509 and recycle gas 504 respectively, and regenerator 1008-3 allows to regenerate the absorbent solution with production of a partly regenerated solution and a totally regenerated solution, as described above for the process illustrated in FIG. 4. H₂S-enriched absorbent solutions 530 and 550 are sent to regenerator 1008-3, partly regenerated solution 540 is recycled to second absorber 1008-2 and totally regenerated solution 520 is recycled to first absorber 1008-1.

Pressure P2 in second absorber 1008-2 is higher than pressure P1 of first absorber 1008-1, by at least 5 bar, preferably at least 10 bar, more preferably at least 20 bar, or even 30 or 40 bar.

Pressure P1 ranges for example between 1 and 190 bar, preferably between 20 bar and 190 bar, more preferably between 40 bar and 190 bar, more preferably yet between 40 bar and 150 bar, and most preferably between 40 bar and 100 bar. Pressure P1 preferably corresponds to the pressure of effluent 509 to be treated. Pressure P2 ranges for example between 10 bar and 200 bar, preferably between 45 bar and 200 bar, more preferably between 50 bar and 200 bar, more preferably yet between 50 bar and 180 bar, and most preferably between 80 bar and 150 bar. Pressure P2 preferably corresponds to the pressure of effluent 504 to be treated. For example, recycle gas 509 is treated at a pressure P1 of 80 bar in first absorber 1008-1 and recycle gas 504 is treated at a pressure P2 of 120 bar in the second absorber.

Any suitable means for subjecting the fluids circulating between the absorbers and the regenerator to pressure and expansion (e.g. valves, pumps, turbine pumps) can be provided so as to reach the operating conditions required in the various columns.

The method according to the invention is not limited to deacidizing of two gaseous effluents of different origins and it could be implemented for treating more than two gaseous effluents. For example, a third absorber could be used to receive a third gaseous effluent from which one or more acid compounds are to be removed, by contacting with a third absorbent solution stream. Depending on the operating conditions of the absorber, notably the operating pressure, the absorbent solution stream introduced can for example be a fraction of the totally regenerated solution, or a fraction of the partly regenerated solution, or two intermediate withdrawal levels can be provided at the regeneration column, thus providing three regenerated solution grades, with one dedicated to each of the three absorbers.

### EXAMPLES

The example relates to the deacidizing method according to FIGS. 3 and 4. The compositions, flow rates, temperature and pressure of gaseous effluents 104 and 109 to be deacidized are given in Table 1 hereafter.

TABLE 1

| | Effluent 109 | Effluent 104 |
|---|---|---|
| | (combustion gas) | (syngas) |
| Pressure (bar a) | 1.02 | 26.7 |
| Temperature (° C.) | 172.6 | 76 |
| Flow rate (kmol/h) | 13640 | 20465 |
| Vapour fraction (%) | 100 | 100 |
| Molar fraction (%) | | |
| Methane | — | 4.3 |
| Hydrogen | — | 74.3 |
| CO | — | 0.8 |
| CO2 | 14.2 | 18.8 |
| O2 | 6.2 | 0 |
| N2 | 65.5 | 0.2 |
| H2O | 13.3 | 1.6 |
| Other organic | — | >ppm by mole |
| constituents | | |
| Ar | 0.8 | |

According to FIGS. 1 and 2 representing the prior art, effluents 104 and 109 can be treated by two distinct amine treating units. These treating units however need to respect a different CO₂ removal rate for each gaseous effluent. For gas 104 representing the syngas, the CO₂ removal rate has to be at least 98.5%. For effluent 109 representing the combustion gas, the CO₂ removal rate has to be at least 90%.

For example, effluents 104 and 109 are treated with an absorbent solution consisting of 30 wt. % monoethanolamine (MEA) aqueous solution. Each gas 104 and 109 is treated in an absorption column and brought into countercurrent contact with an amine solution having a specific CO₂ loading rate, i.e. containing a certain amount of CO₂. The CO₂ loading rate is defined as the amount of CO₂ (in mole) in relation to the amount of amine (in mole). In the present case, the MEA treating units use a 0.24 mol CO₂/mol MEA absorbent solution at the absorber inlet for treating effluent 109 and a 0.28 mol CO₂/mol MEA solution for treating effluent 104. The heat consumption involved in the amine regeneration is quantified in gigajoules per ton of CO₂ removed (GJ/tCO₂).

Table 2 hereafter gives the operating conditions of the two processes using the 30 wt. % MEA, as well as the investment in installed cost of the regenerator of each unit according to the prior art. For the unit treating effluent 104, the regenerator investment is given on a reference basis of 100. For the unit treating effluent 109, the regenerator investment is 80.

TABLE 2

| | Effluent 109 | Effluent 104 |
|---|---|---|
| | (combustion gas) | (syngas) |
| Absorber | | |
| CO₂ removal rate (%) | 90.0 | 98.5 |
| Removed CO₂ flow rate | 76.9 | 49.1 |
| (t/h) | | |
| Absorber pressure (bar | 1.02 | 26.7 |
| a) | | |
| Amine flow rate at | 57845 | 114496 |
| absorber inlet (kmol/h) | | |
| CO₂ loading rate of the | 0.24 | 0.28 |
| solvent at absorber inlet | | |
| (mol CO₂/mol MEA) | | |
| CO₂ loading rate of the | 0.51 | 0.58 |
| solvent at absorber | | |
| outlet (mol CO₂/mol | | |
| MEA) | | |
| Regenerator | | |
| Pressure (bar a) | 1.8 | 1.8 |
| Temperature at bottom | 120 | 120 |
| (° C.) | | |
| Energy consumption | 3.5 | 3.4 |
| (GJ/t CO₂) | | |
| Regenerator investment | 80 | 100 |
| basis | | |

The two absorption units described above use the same solvent (30 wt. % MEA). According to the invention, the same data relative to the absorption of effluents 104 and 109 are used, and regeneration is conducted within a single regenerator, with similarly identical regenerator operating conditions as regards temperature and pressure.

In FIGS. 3 and 4, sharing the regenerator between the two units allows effluents 104 and 109 to be treated within the same treating unit 1007 shown in FIG. 3. FIG. 4 shows the internal layout of unit 1007. The operating conditions and the dimensions of absorbers 1007-1 and 1007-2 are identical to those of the absorbers of the prior art described above. Shared regenerator 1007-3 regenerates the absorbent solutions for absorbers 1007-1 and 1007-2. In FIG. 4, streams 420 and 440 are withdrawn at different heights of the regenerator. Regenerator 1007-3 has larger dimensions due to the greater efficient amine flow to be treated by comparison with the prior art configuration using distinct treating units having each a regenerator. However, the economies of scale on the total investment of the shared section allows to obtain an investment basis for the regenerator of 160, thus reducing by 12% the total investment on the regenerator of unit 1007 in relation to the prior art.

Tables 3 and 4 below give the operating conditions of absorbers 1007-1 and 1007-2, and of regenerator 1007-3.

TABLE 3

| Equipment | 1007-1 | 1007-2 |
|---|---|---|
| CO2 removal rate (%) | 90.0 | 98.5 |
| Removed CO2 flow rate (t/h) | 76.9 | 49.1 |
| Absorber pressure (bar a) | 1.02 | 26.7 |
| Absorber bottom | 55 | 50 |
| temperature (° C.) | | |
| Amine flow rate at absorber | 57845 | 114496 |
| inlet (kmol/h) | | |
| CO₂ loading rate of the | 0.24 | 0.28 |
| solvent at absorber inlet (mol | | |
| CO₂/mol MEA) | | |
| CO2 loading rate of the | 0.51 | 0.58 |
| solvent at absorber outlet | | |
| (mol CO₂/mol MEA) | | |

TABLE 4

| Equipment | 1007-3 |
|---|---|
| Removed CO₂ flow rate (t/h) | 126.0 |
| Regenerator pressure (bar a) | 1.8 |
| Regenerator bottom temperature | 120 |
| (° C.) | |
| Amine flow rate of stream 450 | 114496 |
| (kmol/h) | |
| CO₂ loading rate of stream 450 (mol | 0.58 |
| CO₂/mol MEA) | |
| Amine flow rate of stream 430 | 57845 |
| (kmol/h) | |
| CO₂ loading rate of stream 430 (mol | 0.51 |
| CO₂/mol MEA) | |
| Amine flow rate of the partly | 114496 |
| regenerated solution (stream 440) | |
| (kmol/h) | |
| Amine flow rate of the totally | 57845 |
| regenerated solution (stream 420) | |
| (kmol/h) | |
| Amine loading rate of partly | 0.28 |
| regenerated solution 440 (mol | |
| CO₂/mol MEA) | |
| Amine loading rate of totally | 0.24 |
| regenerated solution 420 (mol | |
| CO₂/mol MEA) | |
| Regenerator investment basis | 160 |

1. A method of removing acid compounds contained in a gaseous effluent, comprising:
contacting, in a first absorption column operating at a first pressure P1, a first gaseous effluent containing acid compounds with a first stream of an aqueous absorbent solution comprising at least one amine, so as to produce a first gaseous effluent depleted in acid compounds and a first solution enriched in acid compounds,
contacting, in a second absorption column operating at a second pressure P2 at least 5 bar higher than first pressure P1, a second gaseous effluent containing acid compounds with a second absorbent solution stream, so as to produce a second gaseous effluent depleted in acid compounds and a second solution enriched in acid compounds,
regenerating the first and second solutions enriched in acid compounds in a regeneration column so as to produce a gas rich in acid compounds, a partly regenerated solution and a totally regenerated solution, and
sending said partly regenerated solution to the second absorption column so as to form the second absorbent solution stream and sending the totally regenerated solution to the first absorption column so as to form the first absorbent solution stream.

2. A method as claimed in claim 1, wherein the first pressure P1 in the first absorption column ranges between 1 bar and 190 bar, and the second pressure P2 in the second absorption column ranges between 10 bar and 200 bar.

3. A method as claimed in claim 1, wherein the second pressure P2 is at least 10 bar higher than the first pressure P1, the first pressure P1 ranges between 1 bar and 6 bar, and the second pressure P2 ranges between 15 bar and 40 bar.

4. A method as claimed in claim 1, wherein the first solution enriched in acid compounds and the second solution enriched in acid compounds have an acid compound loading rate difference ranging between 5% and 30%.

5. A method as claimed in claim 1, wherein the first solution enriched in acid compounds is fed at an intermediate level along the regeneration column so that at least 50% of the acid compounds contained in said solution are released as gas in the regeneration column.

6. A method as claimed in claim 1, wherein the partly regenerated solution is collected at a given height of the regeneration column above the height of discharge of the totally regenerated solution.

7. A method as claimed in claim 1 for CO₂ capture in a hydrogen production process through steam reforming of a gaseous hydrocarbon feed, wherein the first gaseous effluent is a combustion fume from a combustion stage in the hydrogen production process, and the second gaseous effluent is a hydrogen-rich CO₂-containing dry gas mixture, said mixture being obtained in the hydrogen production process after a stage of water gas shift reaction of the CO contained in the reforming effluents and after a cooling and condensation stage.

8. A method as claimed in claim 1 for H₂S capture in a hydrocarbon feed hydrotreating process, wherein the first gaseous effluent and the second gaseous effluent to be treated are recycle gases produced in a first hydrotreating unit and in a second hydrotreating unit respectively.

9. A method as claimed in claim 8, wherein the first pressure P1 ranges between 20 bar and 190 bar, and the second pressure P2 ranges between 45 bar and 200 bar.

10. A plant for removing acid compounds contained in a gaseous effluent for implementing the method as claimed in claim 1, comprising:
a first absorption column and a second absorption column, each comprising:
gas-liquid contacting means,
a first line at the column bottom for delivery of a gaseous effluent to be treated,
a second line at the column top for delivery of an absorbent solution stream,
a third line at the column top for discharge of a treated gaseous effluent depleted in acid compounds, and
a fourth line at the column bottom for discharge of an absorbent solution enriched in acid compounds,
a regeneration column comprising:
gas-liquid contacting means,
a reboiler,
a delivery line for a first solution enriched in acid compounds from first absorption column,
a delivery line for a second solution enriched in acid compounds from second absorption column, at the column top,
a discharge line for a gas rich in acid compounds, at the column top,
a line for discharge of a totally regenerated absorbent solution to the first absorption column, at the column bottom,
a line for discharge of a partly regenerated absorbent solution to the second absorption column.

11. A plant as claimed in claim 10, wherein the delivery line for the first solution enriched in acid compounds is positioned at an intermediate level along the regeneration column, below the line delivering the second solution enriched in acid compounds.

12. A plant as claimed in claim 10, wherein the position of the delivery line for the first solution enriched in acid compounds is determined by taking simultaneously account of the loading rate and the temperature of said solution enriched in acid compounds entering the column, so as to minimize the heat consumption at the reboiler of regeneration column.

13. A plant as claimed in claim 10, wherein the discharge line intended for the partly regenerated absorbent solution is positioned at a given height of the regeneration column above the discharge line intended for a totally regenerated absorbent solution.
